(19) United States
(12) Patent Application Publication
(10) Pub. No.: US 2024/0066809 A1
(43) Pub. Date: Feb. 29, 2024

(54) METHOD FOR PRODUCING A CONTAINER AND A DEVICE FOR CARRYING OUT THE METHOD

(71) Applicant: Krones AG, Neutraubling (DE)

(72) Inventors: Jörg ZACHARIAS, Koefering (DE); Matthias WAHL, Langquaid (DE)

(21) Appl. No.: 18/453,850

(22) Filed: Aug. 22, 2023

(30) Foreign Application Priority Data
Aug. 25, 2022 (DE) 10 2022 121 491.5

(51) Int. Cl. B29C 65/52; B29C 65/48

(52) U.S. Cl. CPC B29C 65/522; B29C 65/482; B29L 2031/7158

(57) ABSTRACT

The disclosure relates to a method for producing a container comprising a bottom, a sidewall, a neck and at least one profiled structure on the neck, wherein a material of the container comprises fibers, for example pulp, wherein the method comprises: producing a blank of the container from the material, wherein the blank comprises the bottom, the sidewall and the neck, and subsequently arranging the at least one profiled structure on the neck of the blank. The disclosure further relates to a device for carrying out the method comprising a molding device for producing the blank of the container from the material, wherein the blank comprises the bottom, the sidewall and the neck, and a arrangement device for arranging the at least one profiled structure on the neck of the blank.

### CROSS REFERENCE TO RELATED APPLICATION

The present application claims priority to German Patent Application No. 10 2022 121 491.5 filed on Aug. 25, 2022. The entire contents of the above-listed application are hereby incorporated by reference for all purposes.

### TECHNICAL FIELD

The disclosure relates to a method for producing a container and a device for carrying out the method.

### BACKGROUND

WO 2019/034704 A1 discloses a method and a device for molding containers from sustainable material, for example pulp. First, a predominantly liquid material is introduced into a mold and a container blank is formed by adhering the material to the inner wall of the mold. By applying pressure to a rubber bubble in the interior, part of the liquid is displaced through the permeable mold wall. The head piece that forms with the container mouth initially has an excess length. In order to form the head piece, an axially displaceable sleeve is used that, when inserted into the mold, shortens the container blank at least slightly, compresses the material on the head piece and also displaces it radially. The container is then dried.

The production technology is comparatively complicated. The forming of a contour that is to be embossed with high precision and is loadable, such as a screw thread for applying a screw cap, is not guaranteed. Due to the type of material input, only one material can be worked with. In general, there is more wet material on the molded head piece than on the rest of the container portions because it has a greater wall thickness, such that drying can be problematic.

### SUMMARY

### Object

The object of the disclosure is to provide a method and a device that allow the production of a container comprising fibers, for example pulp, and having sufficient strength and stability.

### Achievement

The object is achieved by the method and the device described herein.

The method according to the disclosure for producing a container comprising a bottom, a sidewall, a neck, and at least one profiled structure on the neck, wherein a material of the container comprises fibers, for example pulp, wherein the method comprises:

producing a blank of the container from the material, wherein the blank comprises the bottom, the sidewall and the neck,
arranging the at least one profiled structure on the neck of the blank.

The blank of the container does not comprise the profiled structure on the neck. Also, there is no thread and/or no support ring and/or the like on the neck of the blank. Overall, the neck of the blank can comprise a smooth surface.

The method makes it possible, firstly, to produce a simply shaped blank of the container and to decouple the arrangement of the at least one profiled structure on the neck from the production process of the blank.

The at least one profiled structure can be produced independently of the blank, wherein, for example, attention can be paid to a contour of the at least one profiled structure that is to be embossed with high precision and loadable.

The at least one profiled structure can comprise a thread and/or a support ring. The thread and/or the support ring can have high load capacity and/or accuracy requirements.

A first material for the blank of the container and a second material for the at least one profiled structure can be used as the material of the container. The first and the second materials can be different. The second material can meet requirements for a higher load capacity of the at least one profiled structure produced by them.

The second material can comprise curing components, for example wood glue, resin or epoxy resin. The stability of the at least one profiled structure can thereby be increased.

The at least one profiled structure can comprise at least one filament in the interior. For example, the filament can be arranged in the interior of the threaded strand. The stability of the thread strand can be increased by the hardness of the filament.

The subsequent arrangement can sliding a sleeve comprising the at least one profiled structure onto the neck and gluing or pressing the sleeve to the neck to maintain a permanent connection between the sleeve and the neck.

Alternatively, the subsequent arrangement can comprise sliding a wetted sleeve comprising the at least one profiled structure onto the neck and drying the sleeve to maintain a permanent connection between the sleeve and the neck. For example, the drying can be done by means of a drying device or at room temperature. The drying device can comprise a dryer, radiator or heater. Drying at room temperature can be done by waiting for a predetermined period of time. For example, in the method, an initially dry sleeve can be provided that can then initially be moistened in the method before it can be slid onto the neck.

For example, a tube material can be provided that comprises the at least one profiled structure. The sleeves can be correspondingly cut off from this tube material and used for the subsequent arrangement.

Alternatively, the subsequent arrangement can comprise winding a band-like cutting comprising the at least one profiled structure onto the neck and gluing or pressing the band-like cutting to the neck to maintain a permanent connection between the band-like cutting and the neck.

For example, a roller can be provided on which a band-like arrangement of the at least one profiled structure is mounted in a rolled up condition. The band-like cuttings can be correspondingly cut off from this roller and used for the subsequent arrangement.

Alternatively, the subsequent arrangement can comprise spraying the at least one profiled structure onto the neck by means of at least one spray nozzle.

The method can further comprise drying the at least one profiled structure.

The spraying can comprise rotating the blank about its longitudinal axis and thereby adjusting the height of the blank in order to spray on a thread revolving around the neck and/or rotating the blank about its longitudinal axis and spraying a support ring on the neck.

The spraying can comprise directing the at least one spray nozzle along a spiral path on the neck of the blank to spray a thread revolving around the neck.

After the subsequent arrangement, the at least one profiled structure can be coated. By means of the coating, better sliding properties can be achieved, which can reduce friction or the risk of damage when a closure is tightened and/or screwed onto the profiled structure.

The device for carrying out the method, as described above or further below, comprises a molding device for producing the blank of the container from the material, wherein the blank comprises the bottom, the sidewall and the neck, and an arrangement device for arranging the at least one profiled structure on the neck of the blank.

The molding device can comprise a mold into which the material is introduced and molded by means of a rubber bubble or the molding device can comprise an injection molding device.

The device can further comprise a sliding device for sliding the sleeve comprising the at least one profiled structure onto the neck, or a winding device for winding the band-like cutting comprising the at least one profiled structure onto the neck, or a spraying device comprising the at least one spray nozzle for spraying the at least one profiled structure onto the neck.

The device can further comprise a coating device for coating the at least one profiled structure. By means of the coating, better sliding properties can be achieved, which can reduce friction or the risk of damage when a closure is tightened and/or screwed onto the profiled structure.

### BRIEF DESCRIPTION OF THE FIGURES

The accompanying Figures show, by way of example, aspects and/or exemplary embodiments of the disclosure for better understanding and illustration. In the figures:

FIG. 1A shows a blank of the container,

FIG. 1B shows a tube material comprising the at least one profiled structure,

FIG. 1C shows a sleeve cut from the tube material,

FIG. 1D shows a container comprising the blank with the sleeve applied,

FIG. 2A shows a blank of the container,

FIG. 2B a roller comprising a band-like arrangement of the at least one profiled structure,

FIG. 2C shows a band-like cutting cut from the roller,

FIG. 2D shows a container comprising the blank with the band-like cutting applied,

FIG. 3A shows a blank of the container and

FIG. 3B shows a container comprising the blank with a sprayed profiled structure.

### DETAILED DESCRIPTION

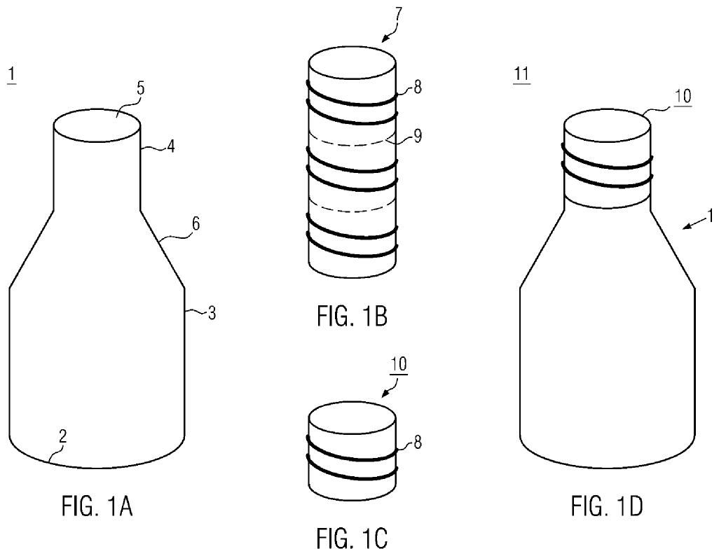

FIG. 1A shows a blank 1 of the container, wherein the blank comprises a bottom 2, a sidewall 3, a shoulder region 6, a neck 4 and a mouth opening. To produce the container, a profiled structure in the form of a sleeve is also applied to the neck 4 of the blank 1.

FIG. 1B shows a tube material 7 comprising the at least one profiled structure 8, in this case in the form of a thread 8. The tube material 7 is designed in such a way that individual sleeves can be cut off and/or separated therefrom, which can then be applied to the neck 4 of the blank 1. Cutting off and/or separating the individual sleeves can be done along a separating seam 9.

FIG. 1C shows a sleeve 10 cut off or separated from the tube material 7.

FIG. 1D shows a container 11 comprising the blank 1 with the sleeve 10 applied. This container 11 can now be closed by means of a corresponding cover, wherein the closure can be designed to be reclosable.

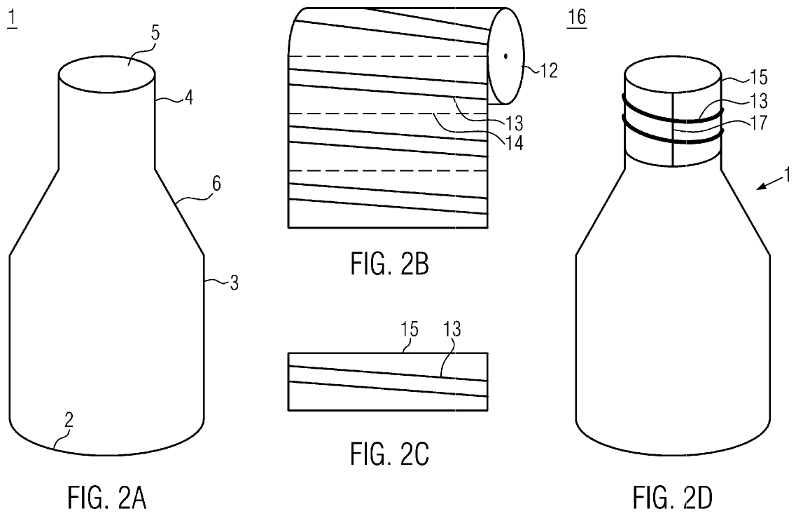

FIG. 2A shows a blank 1 of the container. To produce the container, a profiled structure in the form of a band-like cutting is also applied to the neck 4 of the blank 1.

FIG. 2B shows a roller 12 comprising a band-like arrangement of the at least one profiled structure 13, in this case in the form of a thread. The roller 12 is designed in such a way that individual band-like cuttings can be cut off and/or separated, which can then be applied to the neck 4 of the blank 1. Cutting off and/or separating the individual band-like cuttings can be done along a separating seam 14.

FIG. 2C shows a band-like cutting 15 cut from the roller 12.

FIG. 2D shows a container 16 comprising the blank 1 with the band-like cutting 15 applied. This container 16 can now be closed by means of a corresponding cover, wherein the closure can be designed to be reclosable.

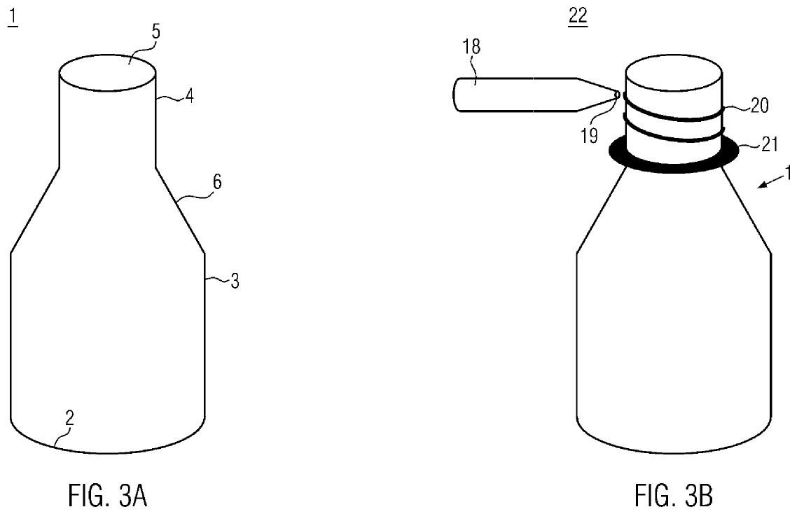

FIG. 3A shows a blank 1 of the container. To produce the container, a profiled structure in the form of a thread and a support ring is sprayed onto the neck 4 of the blank 1.

FIG. 3B shows a container 22 comprising the blank 1 with a sprayed profiled structure, in this case in the form of a thread 20 and support ring 21. Spraying can be done with a spraying device 18 comprising a spray nozzle 19.

1. A method for producing a container comprising a bottom, a sidewall, a neck and at least one profiled structure on the neck, wherein a material of the container comprises fibers, wherein the method comprises:
producing a blank of the container from the material, wherein the blank comprises the bottom, the sidewall and the neck,
arranging the at least one profiled structure on the neck of the blank.

2. The method according to claim 1, wherein the at least one profiled structure comprises a thread and/or a support ring.

3. The method according to claim 1, wherein a first material for the blank of the container and a second material for the at least one profiled structure are used as the material of the container.

4. The method according to claim 3, wherein the second material comprises curing components.

5. The method according to claim 1, wherein the at least one profiled structure in the interior comprises at least one thread.

6. The method according to claim 1, wherein the subsequent arrangement comprises:
sliding a sleeve comprising the at least one profiled structure onto the neck, and
gluing or pressing the sleeve to the neck to maintain a permanent connection between the sleeve and the neck, or
sliding a wetted sleeve comprising the at least one profiled structure onto the neck, and
drying the sleeve to maintain a permanent connection between the sleeve and the neck.

7. The method according to claim 1, wherein the subsequent arrangement comprises:
winding a band-like cutting comprising the at least one profiled structure onto the neck, and
gluing or pressing the band-like cutting to the neck to maintain a permanent connection between the band-like cutting and the neck.

8. The method according to claim 1, wherein the subsequent arrangement comprises:
spraying the at least one profiled structure onto the neck by means of at least one spray nozzle.

9. The method according to claim 8, further comprising drying the at least one profiled structure.

10. The method according to claim 8, wherein the spraying comprises:
rotating the blank about its longitudinal axis and thereby adjusting the height of the blank in order to spray on a thread revolving around the neck, and/or
rotating the blank about its longitudinal axis and spraying a support ring on the neck.

11. The method according to claim 8, wherein the spraying comprises:
directing the at least one spray nozzle along a spiral path on the neck to spray a thread revolving around the neck.

12. The method according to claim 1, wherein the at least one profiled structure is coated after the subsequent arrangement.

13. A device for carrying out the method according to claim 1, wherein the device comprises:
a molding device for producing the blank of the container from the material, wherein the blank comprising the bottom, the sidewall and the neck,
an arrangement device for arranging the at least one profiled structure on the neck of the blank.

14. The device according to claim 13, further comprising:
a sliding device for sliding the sleeve comprising the at least one profiled structure onto the neck; or
a winding device for winding the band-like cutting comprising the at least one profiled structure onto the neck, or
a spraying device comprising the at least one spray nozzle for spraying the at least one profiled structure onto the neck.

15. The device according to claim 13, further comprising a coating device for coating the at least one profiled structure.
